(19) United States
(12) Patent Application Publication
(10) Pub. No.: US 2016/0215646 A1
(43) Pub. Date: Jul. 28, 2016

(54) GAS TURBINE LAMINATE SEAL ASSEMBLY COMPRISING FIRST AND SECOND HONEYCOMB LAYER AND A PERFORATED INTERMEDIATE SEAL PLATE IN-BETWEEN

(71) Applicant: General Electric Company, Schenectady, NY (US)

(72) Inventors: Craig Alan GONYOU, Blanchester, OH (US); Gregory Allen UPDIKE, Liberty Township, OH (US)

(21) Appl. No.: 14/916,906

(22) PCT Filed: Aug. 13, 2014
(86) PCT No.: PCT/US2014/050797

§ 371 Date: Mar. 4, 2016

Related U.S. Application Data
(60) Provisional application No. 61/874,608, filed on Sep. 6, 2013.

(51) Int. Cl. F01D 11/18

(52) U.S. Cl. CPC F01D 11/18; F05D 2220/32; F05D 2230/237; F05D 2230/50; F05D 2240/20; F05D 2240/10; F05D 2250/283

(57) ABSTRACT

A laminate seal assembly, disposed on a stator seal portion and opposite a rotor seal portion of a gas turbine engine comprises a first honeycomb layer having a first edge which engages the rotor portion and a second edge distal from said rotor seal portion, a plurality of honeycomb cells extending between the first edge and the second edge, an intermediate seal plate having a first material surface and a second material surface, the first material surface disposed against the second edge of the first honeycomb layer, a low conductivity structure disposed on the second surface, and a backing plate disposed on against said low conductivity structure, wherein the stator portion may be tuned for thermal growth to match the thermal growth of the rotor portion.

### CROSS-REFERENCE TO RELATED APPLICATIONS

This application is a national stage application under 35 U.S.C. §371(c) of prior filed, co-pending PCT application serial number PCT/US2014/050797, filed on Aug. 13, 2014, which claims priority to U.S. patent application Ser. No. 61/874,608, titled “Double Layer Lattice on Labyrinth Seals for Thermal Matching and Method”, filed Sep. 6, 2013.The above-listed applications are herein incorporated by reference.

### BACKGROUND

Present embodiments relate generally to gas turbine engines. More particularly, but not by way of limitation, present embodiments relate to a laminate lattice structure for thermal matching of seal components and associated methods.

A typical gas turbine engine generally possesses a forward end and an aft end with its several core or propulsion components positioned axially therebetween. An air inlet or intake is at a forward end of the gas turbine engine. Moving toward the aft end, in order, the intake is followed by a compressor, a combustion chamber, a turbine, and a nozzle at the aft end of the gas turbine engine. It will be readily apparent from those skilled in the art that additional components may also be included in the gas turbine engine, such as, for example, low-pressure and high-pressure compressors, and high-pressure and low-pressure turbines. This, however, is not an exhaustive list. A gas turbine engine also typically has an internal shaft axially disposed along a center longitudinal axis of the gas turbine engine. The internal shaft is connected to both the turbine and the air compressor, such that the turbine provides a rotational input to the air compressor to drive the compressor blades.

In operation, air is pressurized in a compressor and mixed with fuel in a combustor for generating hot combustion gases which flow downstream through turbine stages. These turbine stages extract energy from the combustion gases. A high pressure turbine first receives the hot combustion gases from the combustor and includes a stator nozzle assembly directing the combustion gases downstream through a row of high pressure turbine rotor blades extending radially outwardly from a supporting rotor disk. In a multi-stage turbine, a second stage stator nozzle assembly is positioned downstream of the first stage blades followed in turn by a row of second stage rotor blades extending radially outwardly from a second supporting rotor disk. The turbine converts the combustion gas energy to mechanical energy. The low pressure turbine blades and rotor disk are mechanically coupled to a low pressure or booster compressor for driving the booster compressor and additionally an inlet fan. The connection with the inlet fan may be direct or indirect, for example through a gearbox.

During the operation of the gas turbine engine, it is desirable to minimize parasitic flow losses to improve on efficiency and performance of the gas turbine engine. One location of the loss is in the labyrinth seal area where seal teeth on the rotor portion of the seal may expand or contract at a different rate than the stator portion of the seal, typically embodied by an opposed honeycomb material.

In typical seal arrangements, the stator portion of the seal may grow in a radial direction, due to thermals, more rapidly than the rotor portion grows thermally. Such growth differential results in opening between the sealing features and reduced functionality of the seal. During transient engine operations such as a burst of increased throttle, and due to thermal mass and air lag differences, the stator portion of known labyrinth seals tend to grow thermally more rapidly than the rotor portion of the seal. The difference in growth rates tend to occur due to the heat affecting the backing plate of a stator portion faster than support structure for the rotating lab seal, such as disk bore and web. As a result, gaps between the stator portion and the rotor portion form which allow high temperature gases to leak. The growth differential may result in exhaust gas temperature overshoot during such transient burst. Therefore, it is desirable to reduce flow through the seal during such transient operation.

As may be seen by the foregoing, it would be desirable to overcome these and other leakages with seal assemblies in order to reduce parasitic flow losses and decrease the turbine temperature overshoot during transient operations, such as for non-limiting example throttle movements.

The information included in this Background section of the specification, including any references cited herein and any description or discussion thereof, is included for technical reference purposes only and is not to be regarded subject matter by which the scope of the invention is to be bound.

### SUMMARY OF THE INVENTION

According to present embodiments, a seal assembly is provided which thermally matches the stator and rotor growths so that differential growth between the stator and rotor is minimized. The growth of the stator portion of the seal is tuned to more closely approximate the slower growth of the rotor. Such growth may occur due to conduction, from the hot side of the seal assembly through to the rotor and to the stator portion backing plate. Accordingly, the rotor and stator can be provided with more similar deflection rates which result in decreased gaps between the rotor and stator portions.

According to some embodiments, a laminate seal assembly disposed on a stator seal portion and opposite a rotor seal portion of a gas turbine engine comprises a first honeycomb layer having a first edge which engages the rotor seal portion and a second edge distal from the rotor seal portion, a plurality of cells extending between the first edge and the second edge, an intermediate seal plate having a first material surface and a second material surface, the first material surface disposed against the second edge of the first honeycomb layer, a low conductivity structure disposed on the second surface, and a backing plate disposed against said low conductivity structure, wherein the stator seal portion may be tuned for thermal growth to match the thermal growth of the rotor seal portion.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. All of the above outlined features are to be understood as exemplary only and many more features and objectives of the invention may be gleaned from the disclosure herein. Therefore, no limiting interpretation of this summary is to be understood without further reading of the entire specification, claims, and drawings included herewith. A more extensive presentation of features, details, utilities, and advantages of the present invention is provided in the following written description of various embodiments of the invention, illustrated in the accompanying drawings, and defined in the appended claims.

### BRIEF DESCRIPTION OF THE DRAWINGS

The above-mentioned and other features and advantages of this disclosure, and the manner of attaining them, will become more apparent and the thermally matched seal portions will be better understood by reference to the following description of embodiments taken in conjunction with the accompanying drawings, wherein:

FIG. 1 is a side section view of a gas turbine engine;

FIG. 2 is a side section view of an exemplary labyrinth seal;

FIG. 3 is an exploded assembly view of a laminate seal assembly;

FIG. 4 is an assembled side section view of the embodiment of FIG. 3;

FIG. 5 is exploded assembly view of a second embodiment;

FIG. 6 is a section view of the second embodiment of a laminate seal assembly;

FIG. 7 is a line chart of transient flow effects over a time period in various seal;

FIG. 8 is a process chart for forming an entire stator part in an additive manufacturing process; and,

FIG. 9 is an alternative process chart wherein a honeycomb is formed separately and joined with other parts that are formed in an additive manufacturing process.

### DETAILED DESCRIPTION

Reference now will be made in detail to embodiments provided, one or more examples of which are illustrated in the drawings. Each example is provided by way of explanation, not limitation of the disclosed embodiments. In fact, it will be apparent to those skilled in the art that various modifications and variations can be made in the present embodiments without departing from the scope or spirit of the disclosure. For instance, features illustrated or described as part of one embodiment can be used with another embodiment to still yield further embodiments. Thus it is intended that the present invention covers such modifications and variations as come within the scope of the appended claims and their equivalents.

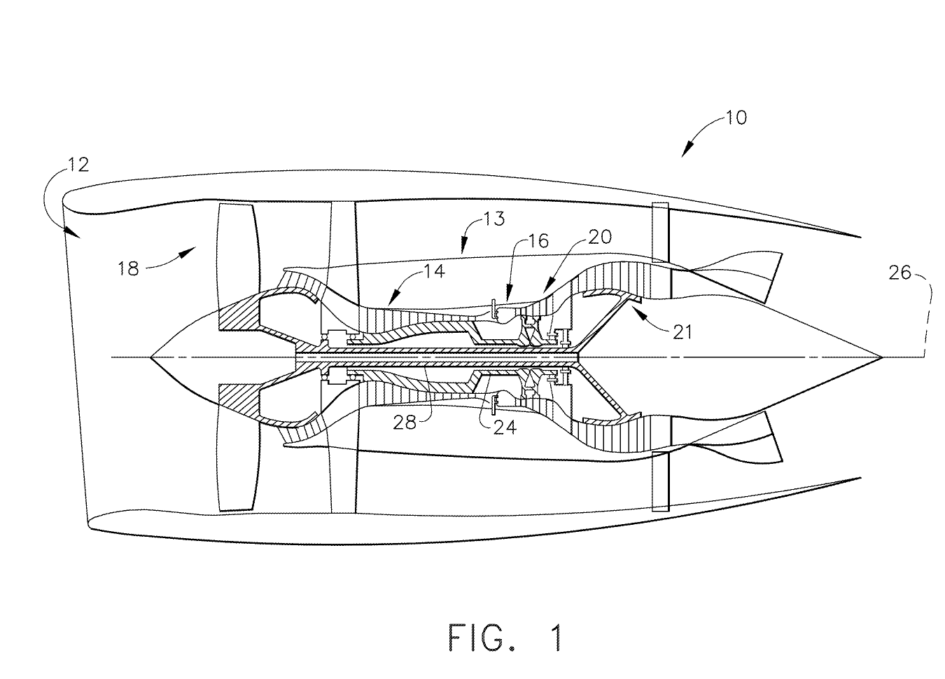

Referring to FIGS. 1-9 various embodiments of a double layer laminate labyrinth seal are depicted. The laminate thermally isolates a backing plate of the stator seal portion of the labyrinth seal assembly. As a result, the thermal growth of the stator seal portion may be controlled or tuned in order to more closely approximate or thermally match the growth in the radial direction of the rotor seal portion. Typically, the stator seal portion thermal growth occurs faster than the rotor seal portion thermal growth in the radially outward direction. Accordingly, instant embodiments slow the growth of the stator seal portion in the radially outward direction, for example during transient operation. In this way, the stator seal portion does not grow radially away from the rotor seal portion as quickly as in the prior art, which decreases seal flow or parasitic losses across the seal. Additionally, exhaust gas temperature overshoot is reduced as a result of the decreased seal flow which improves engine durability.

As used herein, the terms “axial” or “axially” refer to a dimension along a longitudinal axis of an engine. The term “forward” used in conjunction with “axial” or “axially” refers to moving in a direction toward the engine inlet, or a component being relatively closer to the engine inlet as compared to another component. The term “aft” used in conjunction with “axial” or “axially” refers to moving in a direction toward the engine outlet, or a component being relatively closer to the engine nozzle as compared to another component.

As used herein, the terms “radial” or “radially” refer to a dimension extending between a center longitudinal axis of the engine and an outer engine circumference.

All directional references (e.g., radial, axial, proximal, distal, upper, lower, upward, downward, left, right, lateral, front, back, top, bottom, above, below, vertical, horizontal, clockwise, counterclockwise) are only used for identification purposes to aid the reader's understanding of the present invention, and do not create limitations, particularly as to the position, orientation, or use of the invention. Connection references (e.g., attached, coupled, connected, and joined) are to be construed broadly and may include intermediate members between a collection of elements and relative movement between elements unless otherwise indicated. As such, connection references do not necessarily infer that two elements are directly connected and in fixed relation to each other. The exemplary drawings are for purposes of illustration only and the dimensions, positions, order and relative sizes reflected in the drawings attached hereto may vary.

Referring initially to FIG. 1, a schematic side section view of a gas turbine engine 10 is shown having an air inlet end 12 wherein air enters the core 13 which is defined generally by a high pressure compressor 14, a combustor 16 and a multi-stage high pressure turbine 20. Collectively, the core 13 provides power during operation. Although the gas turbine engine 10 is shown in an aviation embodiment, such example should not be considered limiting as the gas turbine engine 10 may be used for aviation, power generation, industrial, marine or the like.

In operation, air enters through the air inlet end 12 of the gas turbine engine 10 and moves through at least one stage of compression where the air pressure is increased and directed to the combustor 16. The compressed air is mixed with fuel and burned providing the hot combustion gas which exits the combustor 16 toward the high pressure turbine 20. At the high pressure turbine 20, energy is extracted from the hot combustion gas causing rotation of turbine rotors which in turn causes rotation of the high pressure shaft 24. The high pressure shaft 24 passes toward the front of the gas turbine engine 10 to rotate the one or more high pressure compressor 14 stages. A fan 18 is connected by the high pressure shaft 24 to a low pressure turbine 21 and creates thrust for the gas turbine engine 10. The low pressure turbine 21 may also be utilized to extract further energy and power additional compressor stages. The low pressure air may be used to aid in cooling components of the gas turbine engine as well.

The gas turbine engine 10 is axis-symmetrical about engine axis 26 so that various engine components rotate thereabout. An axi-symmetrical high pressure shaft 24 extends through the turbine engine forward end into an aft end and is journaled by bearings on the shaft structure. The high pressure shaft 24 rotates about an axis 26 of the gas turbine engine 10. The high pressure shaft 24 may be hollow to allow rotation of a low pressure turbine shaft 28 therein and independent of the high pressure shaft 24 rotation. The low pressure shaft 28 also may rotate about the engine axis 26 of the gas turbine engine 10. During operation the low pressure shaft 28 rotates along with other structures connected to the low pressure shaft 28 such as the rotor assemblies of the turbine in order to create power or thrust in both industrial, marine, land or aviation uses.

Referring still to FIG. 1, the instant embodiments may be related to the seal assemblies throughout the engine where it is desirable to minimize the amount of cooling air extracted from the compressor 14 and allow it to remain in the primary flowpath for work extraction in the high pressure turbine 20.

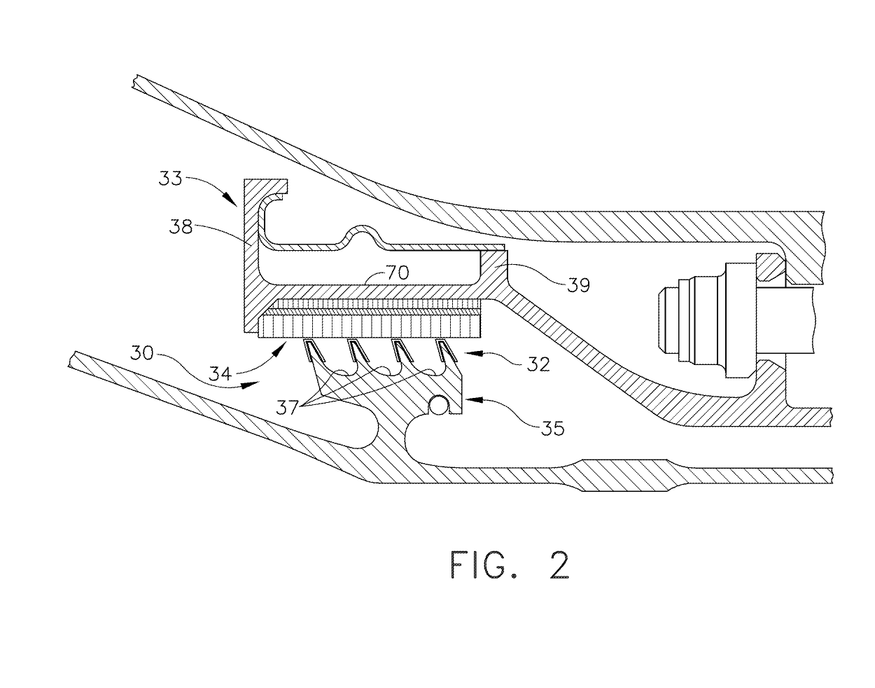

Referring now to FIG. 2, a side section view of a labyrinth seal assembly 30 is depicted including a rotor seal portion 35 comprising a plurality of seal teeth 32 which are positioned opposite a stator seal portion 33. The rotor has a rotor seal portion 35 engaging the stator seal portion 33. The labyrinth seal assembly 30 provides a small clearance between the tips of seal teeth 32 and the innermost surface of the stator seal portion 33. The rotor seal portion 35 of the rotor may include the one or more seal teeth 32 which engage the stator seal portion 33. Between the first and second toothed sections there is a radially inward section 37 that is a smooth cylindrical surface having a diameter less than the outer diameter of the tips of the labyrinth seal teeth 32.

The plurality of seal teeth 32 in the rotor seal portion 35 may be coated with an abradable material. The abradable material is optional and therefore may or may not be utilized. The seal teeth 32 engage the opposite stator seal portion 33 during operation, and more specifically a laminate seal assembly 34, for example honeycomb seal assembly. In transient conditions, the stator seal portion 33 of prior art seals grows in a radial direction faster than the rotor seal portion 35.

During engine operation, the rotor seal portion 35, including the seal teeth 32, rotate relative to the stator seal portion 33 or laminate seal assembly 34. The seal teeth 32 engage the laminate seal assembly 34 to seal in an axial direction. The labyrinth seal assembly 30 provides a seal between the generally high pressure areas of the gas turbine engine 10 and the lower pressure areas through which cooling air passes. The seal teeth 32 rotate with rotation of either or both shafts 24, 28. The laminate seal assembly 34 is formed of a laminate of various structures according to the embodiments of the instant disclosure. In function, the labyrinth seal assembly 30, including the laminate seal assembly 34, significantly reduces transient seal flow, pulling less flow from the combustor and into the blade cooling circuits during transient operation.

As mentioned previously, one problem with rotor seal assemblies 30 involves difference in thermal growth rates of the stator seal portion 33 and the rotor seal portion 35 embodied by the seal teeth 32. By providing the transient thermal matching of the labyrinth seals, parasitic flow losses are decreased resulting in increased engine performance and overall decrease in specific fuel consumption (SFC). The instant embodiment insulates the seal backing plate 70 with a double layer of honeycomb, lattice or other insulating material to provide improved transient seal match. Static seals are transiently fast in reaction and slowing their response is generally beneficial to engine efficiency and operation. Such thermal matching minimizes leakage through the labyrinth seal assembly 30. The instant embodiments minimize conduction up to the backing plate 70 from the hot side of the seal teeth 32 area of the labyrinth seal assembly 30. The decreased amount of heat being added to the backing plate 70 and the control rings 38, 39 of the labyrinth seal assembly 30 allow the seal to thermally deflect slower during a transient response of the engine. In turn, this allows the rotor and stator seal portions 35, 33 to have similar thermal time constraints such that the thermal deflections of each component can be matched as required, especially during transient conditions. According to instant embodiments, the laminate seal assembly 34 allows for tuning of the labyrinth seal assembly 30 as needed.

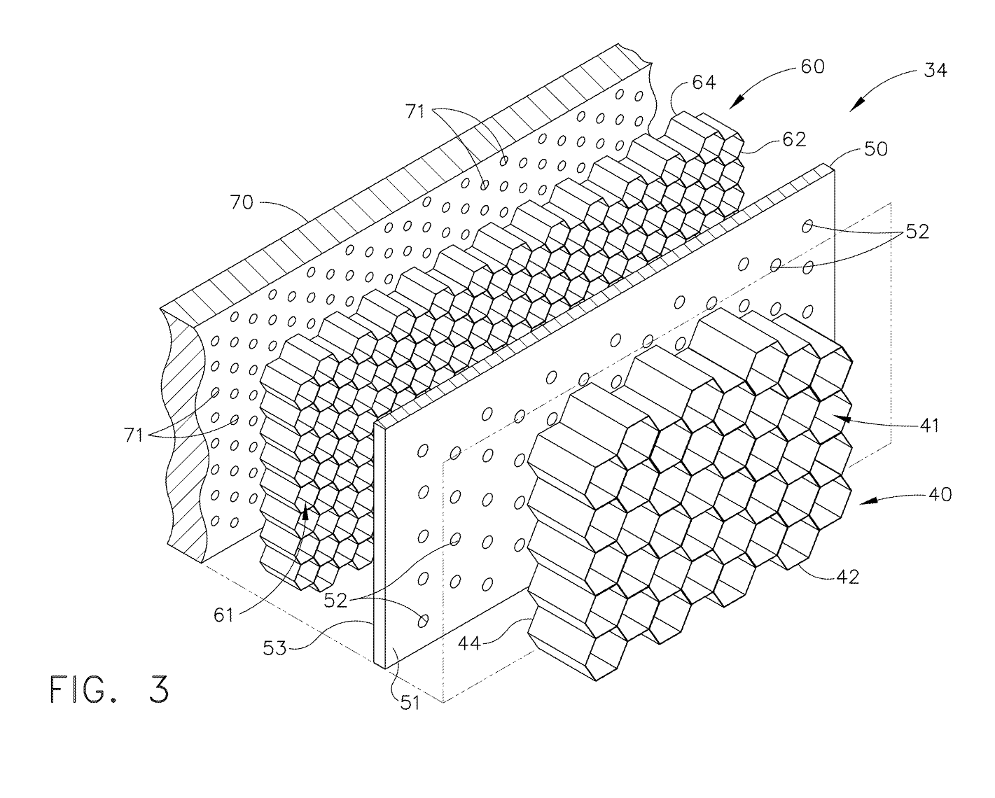

Referring now to FIG. 3, an exploded assembly of a first embodiment of the laminate seal assembly 34 is depicted. The laminate seal assembly 34 is formed of a laminate of materials and comprises a radially inward first honeycomb layer 40 which is closest to the seal teeth 32 (FIG. 2) during operation of the engine. The first honeycomb layer 40 includes a plurality of honeycomb cells 41 defined by thin walls. The first honeycomb layer 40 is made of a plurality of honeycomb cells 41 which are generally hollow and extend between a first edge 42 and a second edge 44. Although the term “honeycomb” is utilized herein, the term should not be considered to be limiting of the geometric shape of the honeycomb cells 41. While six-sided cells are shown, the various shapes may be utilized including circular, square, rectangular or other geometric shapes. The honeycomb cells 41 each have a height extending from a first edge 42 to a second edge 44 of the first honeycomb layer 40. The first honeycomb layer 40 material is formed of a metal or alloy suitable for use within a gas turbine engine as will be understood by one skilled in the art.

Spaced radially outward from the first honeycomb layer 40 is an intermediate seal plate 50 which provides a surface to which the first honeycomb layer 40 may be attached, for example by brazing. The intermediate seal plate 50 functions as a base layer of the first honeycomb layer 40 and may vary in thickness. The intermediate seal plate 50 may be formed of a metallic or alloy sheet or may be formed of other bonding or coating materials, for example a CMC material or lattice structure. The intermediate seal plate 50 may have a first surface 51 and a second surface 53.

The intermediate seal plate 50 may be solid or may include a number of perforations 52. Such perforations allow for thermal communication between the lower pressure side of the laminate seal assembly 34 and the cooler side including the backing plate 70. Thermal matching allows variation of the quantity, size and location of the perforations 52, hence there may be fewer or more perforations than honeycomb cells 41, with them being optional or not necessary at a minimum. In the instant embodiment, the perforations 52 correspond to each honeycomb cell 41 of the first honeycomb layer 40. However, the perforations 52 are optional and not necessary. According to some embodiments, the perforations 52 may be arranged based upon the amount of thermal activation desired. For example, more perforations 52 may be added if additional heat is desired to pass from the rotor side of the labyrinth laminate seal assembly 34 toward the backing plate 70. Alternatively, if less heat transfer is desired toward the backing plate 70, fewer perforations 52 may be provided. Additionally, while the depicted embodiment includes one perforation 52 per honeycomb cell 41, this is also an exemplary embodiment and fewer perforations may be utilized. As a further alternative, it is contemplated that perforation 52 size may also be varied to affect the amount of heat passing through the laminate seal assembly 34 toward the backing plate 70. Even further, the perforations 52 may be arranged randomly or may be arranged in a pattern. Collectively, these various conditions allow for tuning of the labyrinth seal assembly 30 to provide more or less heat and therefore tune the thermal growth to thermally match the rotor seal teeth 32 and stator seal portion 33. It should be understood, however, that while perforations 52 and perforations 71 may be utilized separately, they may not be utilized together which would allow air to pass from the first honeycomb layer 40 through the backing plate 70. Further, one skilled in the art will understand that there is no definitive correlation between the number, size, shape or location of perforations 52 and the honeycomb cells 41 of the first honeycomb layer 40. The variation of the characteristics of the perforations 52 relative to the honeycomb cells 41 allow for improved thermal tuning of the stator seal portion 33 (FIG. 2).

In terms of function, the intermediate seal plate 50 serves to insulate an adjacent second honeycomb layer 60 radially outwardly from the intermediate seal plate 50. The amount of insulation may be controlled by the various adjustable characteristics of the intermediate seal plate 50. According to the instant embodiment, the intermediate seal plate 50 is a metal or other type backing plate. The intermediate seal plate 50 may be a braze of the second honeycomb layer 60 to the backing plate 70. The insulative function creates a thermally dead cavity within the second honeycomb layer 60 positioned above the first honeycomb layer 40 and intermediate seal plate 50. Thus, the second honeycomb layer may also be referred to as a low conductivity structure. The thickness of the second honeycomb layer 60 may be greater than, less than or equal to the first honeycomb layer 40. The second honeycomb layer 60 includes a radially inward edge 62 and a radially outward edge 64. Further, the second honeycomb layer 60 includes a plurality of honeycomb cells 61. As previously described with respect to the first honeycomb layer 40, the honeycomb cells 61 may take various forms and shapes. The honeycomb cells 61 are hollow and while the depicted shape is hexagonal, other shapes may be utilized. As previously indicated, the honeycomb cells 61 may be thermally dead as they are insulated on radially inner and outer sides by the intermediate seal plate 50 and the backing plate 70, respectively. However, perforations 71 or 52 allow for activation of the honeycomb cells 61 to the desired amount by sizing the perforations and quantity of perforations.

Above the second honeycomb layer 60 is the backing plate 70. The backing plate 70 may include a plurality of perforations 71 to communicate with the second honeycomb layer 60 from the backside or radially outward side of the backing plate 70. Alternatively, the backing plate 70 may not have any perforations. As with the intermediate seal plate 50, the perforations 71 may vary in size, shape and pattern. For example, each perforation 71 may correspond to a cell 61, or alternatively may not correspond to each cell 61 as depicted. As a further alternative, the perforation 71 may be of consistent size to provide tuning desired for thermal seal matching. Additionally, the perforations 71 may be arranged in a pattern or may be arranged randomly. On this radially outward side of the backing plate 70 is cooler air which may be communicated through the perforations 71 in order to provide cooling air to one or more of the honeycomb cells 61 within the second honeycomb layer 60 and the intermediate seal plate 50. One skilled in the art will understand that there is no definitive correlation between the number, size, shape or location of perforations 71 and the honeycomb cells 61 of second honeycomb layer 60. The variation of the characteristics of the perforations 71 allow for improved thermal tuning of the stator seal portion 33.

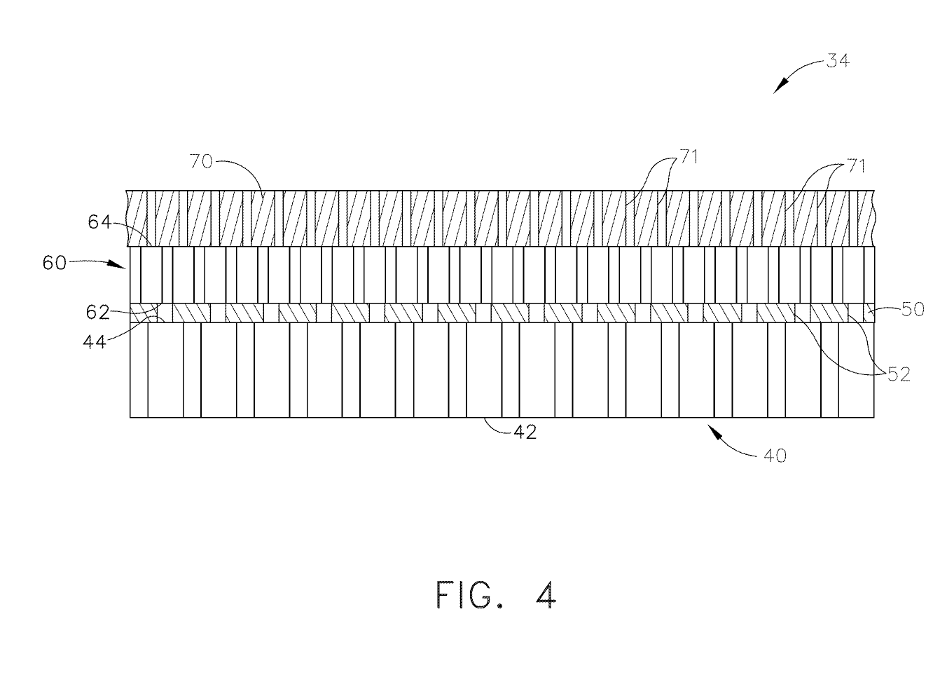

Referring now to FIG. 4, an assembled side view of the embodiment of FIG. 3 is depicted in section view. As can be seen, the perforations in the plates 50, 70 may be aligned with the cells in the layers 40, 60. Again, it should be understood that various changes may be within the scope of the instant embodiment. For example, the number of perforations may be changed, the spacing and shape of the perforations may be varied or in the alternative, may be arranged in a preselected pattern. Likewise, the depth of the intermediate seal plate 50 may be changed as opposed to the first honeycomb layer 40 and the second honeycomb layer 60. This view is exemplary and one skilled in the art will understand that air cannot be allowed to pass from the upper side of the laminate seal assembly 34 to the lower side. Thus, perforations 52, 71 may not be used together as air can pass completely.

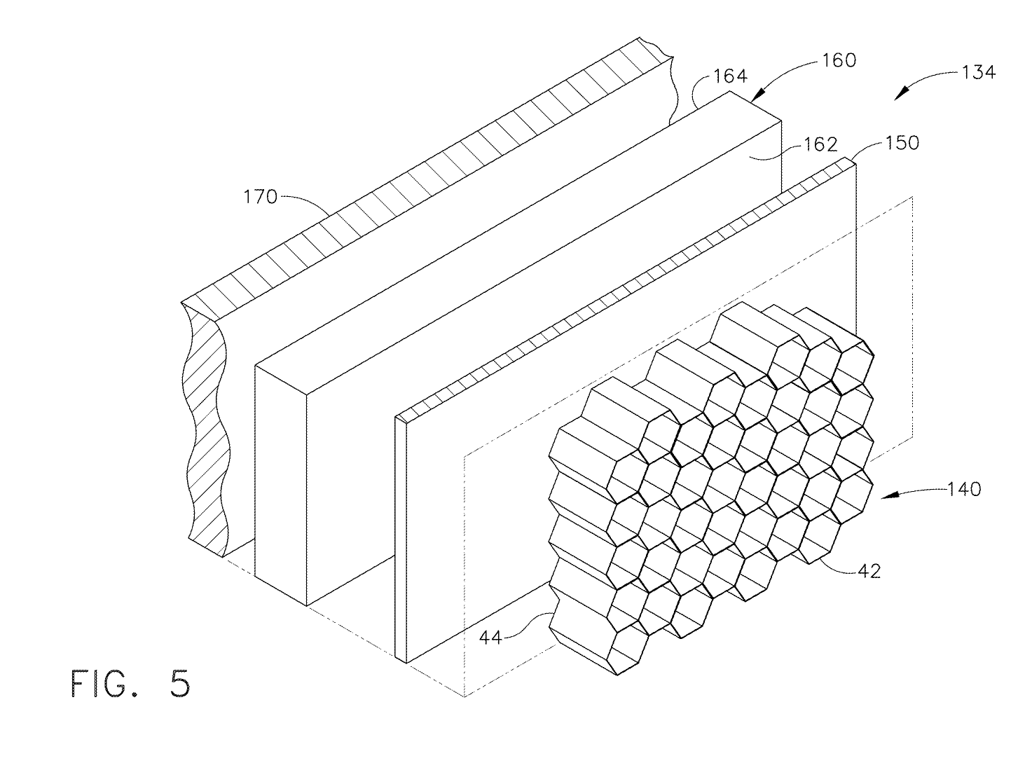

Referring now to FIG. 5, an exploded assembly view of a second embodiment of the double layer laminate seal assembly 134 is depicted. The thermal laminate structure includes a first radially inward honeycomb layer 140 which may be of similar description to the first honeycomb layer 40 previously described. For example, the first honeycomb layer 140 includes an inner edge 142 and an outer edge 144. Positioned on the radially outer edge 144 of the first honeycomb layer 140 is an intermediate seal plate 150 which may be a low conductivity material positioned between the first honeycomb layer 140 and a low conductivity structure 160. The intermediate seal plate 150 may or may not be bonded to the low conductivity structure 160. The intermediate seal plate 150 may include a plurality of apertures or may be solid as depicted. In the instance that perforations are utilized, they may vary in size, shape, number and arrangement as previously described.

Above or radially outward from the intermediate seal plate 150 is the low conductivity structure 160 which according to instant embodiments, is ceramic matrix composite (CMC), which is a non-metallic material having high temperature capability and low ductility. The low conductivity structure 160 may have an inner surface 162 and an outer surface 164. Generally, CMC materials include a ceramic fiber, for example a silicon carbide (SiC), forms of which are coated with a compliant material such as boron nitride (BN). The fibers are coated in a ceramic type matrix, one form of which is silicon carbide (SiC). Typically, the layer 160 is constructed of low-ductility, high-temperature-capable materials. CMC materials generally have room temperature tensile ductility of less than or equal to about 1% which is used herein to define a low tensile ductility material. More specifically, CMC materials have a room temperature tensile ductility in the range of about 0.4% to about 0.7%. Exemplary composite materials utilized for such liners include silicon carbide, silicon, silica or alumina matrix materials and combinations thereof. Typically, ceramic fibers are embedded within the matrix such as oxidation stable reinforcing fibers including monofilaments like sapphire and silicon carbide (e.g., Textron's SCS-6), as well as rovings and yarn including silicon carbide (e.g., Nippon Carbon's NICALON ®, Ube Industries' TYRANNO®, and Dow Corning's SYLRAMIC®), alumina silicates (e.g., Nextel's 440 and 480), and chopped whiskers and fibers (e.g., Nextel's 440 and SAFFIL®), and optionally ceramic particles (e.g., oxides of Si, Al, Zr, Y and combinations thereof) and inorganic fillers (e.g., pyrophyllite, wollastonite, mica, talc, kyanite and montmorillonite). CMC materials typically have coefficients of thermal expansion in the range of about 1.3×10⁻⁶ in/in/degree F to about 3.5×10⁻⁶ in/in/degree F in a temperature of approximately 1000-1200 degree F.

CMC materials have a characteristic wherein the materials tensile strength in the direction parallel to the length of the fibers (the “fiber direction”) is stronger than the tensile strength in the direction perpendicular. This perpendicular direction may include matrix, interlaminar, secondary or tertiary fiber directions. Various physical properties may also differ between the fiber and the matrix directions.

Disposed radially outwardly of the low conductivity structure 160 is the backing plate 170. As with the previous embodiment, the laminate seal assembly 134 limits transient reaction by reducing the heat load through the backing plate 170. This reduces the thermal response of the laminate seal assembly 134 which slows the thermal response of the low conductivity structure 160. Consequently, reduced parasitic flows result in reduced SFC and less mechanical degradation while improving performance of the gas turbine engine 10.

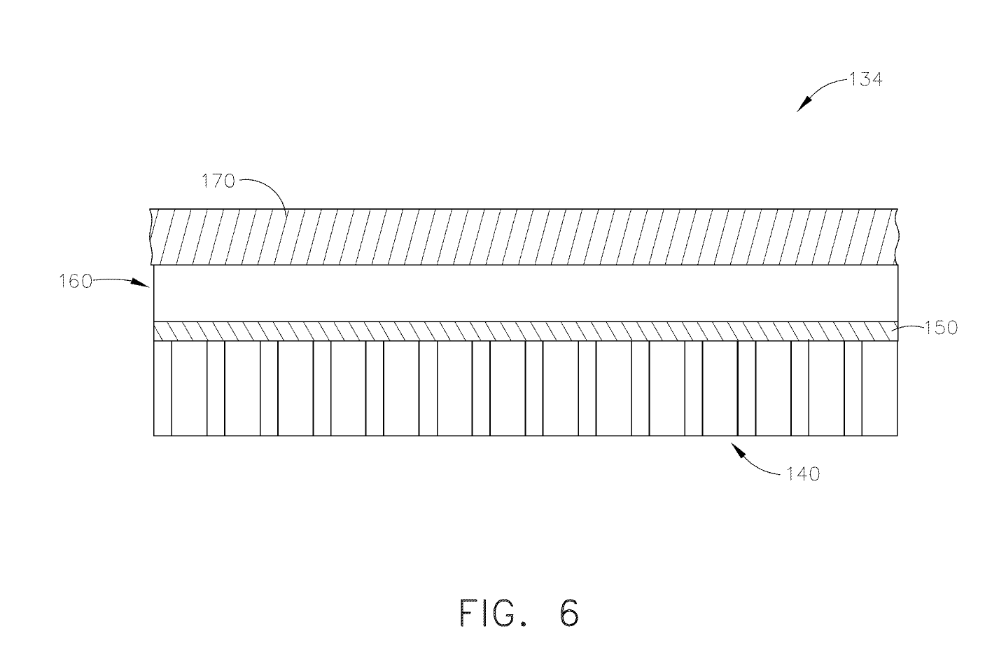

Referring now to FIG. 6, an assembled side section view of the second embodiment is depicted. The laminate seal assembly 134 includes the radially inner honeycomb layer 140 which is connected the intermediate seal plate 150. The bond may, according to the instant embodiment, or may not have a plurality of perforations. Depicted above the intermediate seal plate 150 is the low conductivity structure 160 which further insulates the backing plate 170 from the heat of the lower side of the honeycomb layer 140.

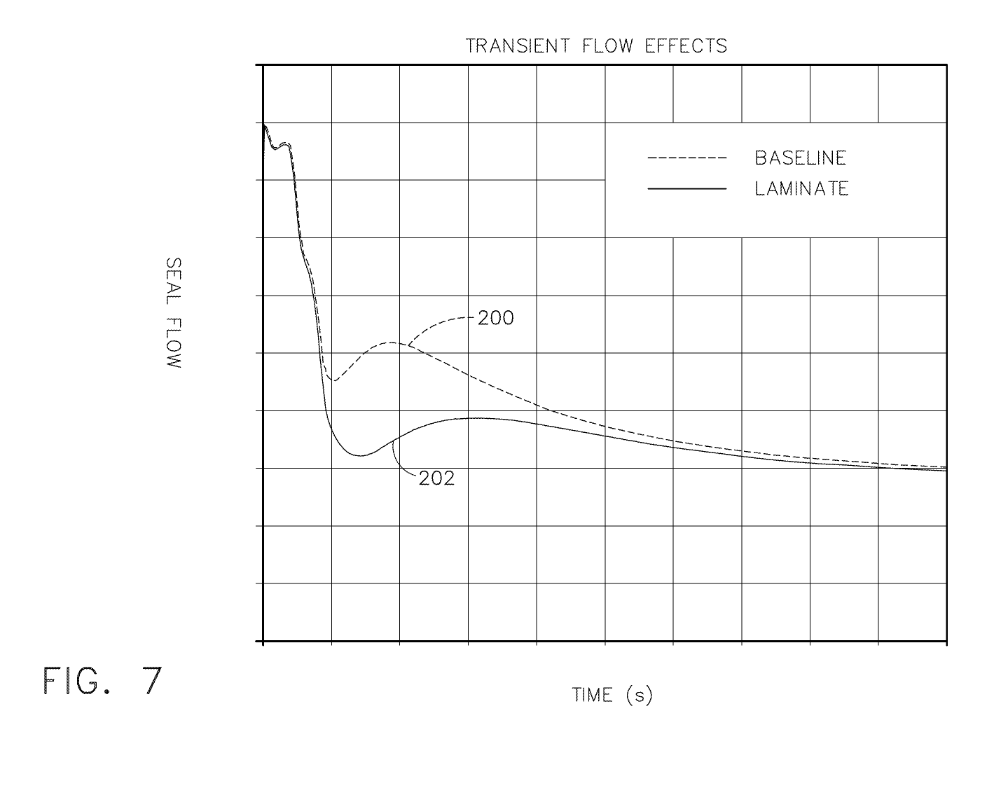

Referring now to FIG. 7, a line graph is depicted which charts transient flow effects of prior art laminate seal assemblies 34. As one skilled in the art will realize, the instant embodiments serve to slow the thermal growth of the stator seal portion 33. The measurement labeled seal flow is indicative of the transient radial gap of a labyrinth seal assembly 30. During transient operation, such as burst of throttle increase, the faster growth of the stator assembly results in leakage of flow across the labyrinth seal assembly 30. Reduction of such differential growth between stator and rotor portions 33, 35 of the seal results in lower seal flow.

In the line graph, seal flow is provided on one axis versus time listed on the horizontal axis. During transient throttle increase, the upper broken line 200 depicts an increase in seal flow at a specific period of time corresponding to the transient engine operation with prior art seals. However, the lower solid line 202 represents seal flow for the laminate seal arrangements of the instant embodiment. As shown, the solid line 202 of seal flow is markedly less than that of the prior art seal assembly represented by broken line 200. This decrease is due to the thermally matched structure of the labyrinth seal assembly 30 wherein growth of the stator seal portion 33 is slowed to more closely match the growth of the rotor seal portion 35.

Over time, both seal portions 33, 35 return to a steady state condition as the seal flows normalize. However, during this transient operation, the flow rate is clearly improved with the laminate seal assemblies 34.

In order to manufacture, the instant embodiments may be formed in various techniques. Manufacture of prior art labyrinth seals with a single layer generally involves brazing of the honeycomb section to the backing plate. For seals with a single honeycomb layer, the braze joint may be visually inspected through the open end of the honeycomb cells. Using the same braze process for the instant embodiments would result in at least 2 more brazing cycles, increasing part cost and manufacturing cycle time. The intermediate seal plate 50 would also block the view of the braze joint between a second layer of honeycomb 60 and the backing plate 70, making inspection processes challenging. Since the braze material may fill any perforations 52 or 71, the perforations 52, 71 would need to be drilled after the brazing process. This would mean drilling operations would occur inside honeycomb cells 41 for perforations 52. Any desired perforations 71 would have to be drilled from the distal surface of backing plate 70 without a view of the second honeycomb layer 60, making it very difficult to line up perforations 71 to honeycomb cells 61, if intended.

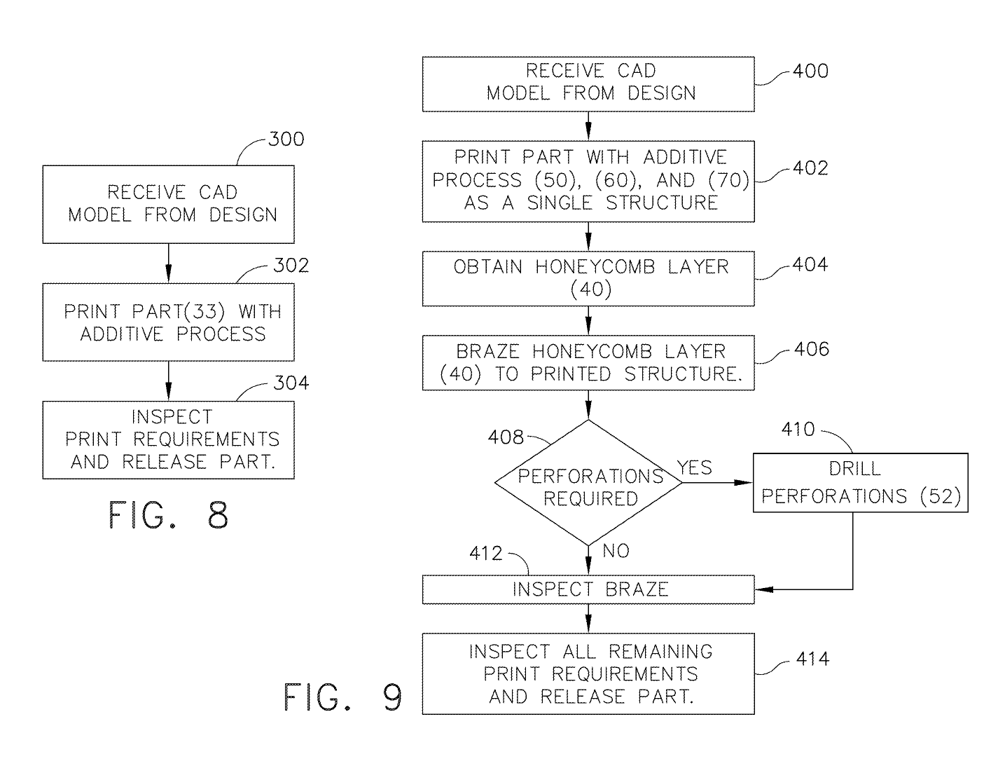

Alternative methods of manufacturing the instant embodiments may resolve some of the challenges stated above. For example, the embodiments may be formed in an additive manufacturing process. The additive manufacturing process may allow all or part of the stator seal portion 33 to be manufactured as one piece, eliminating the need for the brazing process and its subsequent inspection. According to one embodiment, and with reference now to FIG. 8, the entire stator seal portion 33 is formed by way of additive manufacturing, also commonly referred to as 3D printing. The printed part may include the entire stator seal portion 33 including control rings 38, 39 and laminate seal assembly 34 or may be the laminate seal assembly 34 alone. According to the instant embodiment, CAD model files are received at step 300 by the printer controller. At step 302, the part is printed in the additive manufacturing process. Next, at step 304, the part is inspected. At this point, only a single inspection is required rather than multiple inspections for each of the brazing steps discussed above. This significantly reduces manufacturing cost and cycle time. Any desired perforations 52 or 71 may also be created during the additive manufacturing process, further decreasing product cost and cycle time through elimination of perforation drilling processes.

Through operation of the gas turbine engine 10, the first honeycomb layer 40 that engages the rotor seal portion 35 may be degraded by contact with seal teeth 32. With reference now to FIG. 9, it may be desirable to replace only the first honeycomb layer 40 to restore the sealing characteristics of a new seal during an engine overhaul event. For this reason, it may be beneficial to use the traditional braze process for adjoining first honeycomb layer 40 (or 140) to the intermediate seal plate 50 (or 150) that has been manufactured together with the second honeycomb layer 60 (160) and the backing plate 70 (or 170) with an additive manufacturing process. In this process embodiment, the part 50, 60, 70 or alternatively 150, 160, 170 are formed by additive manufacturing. A traditional honeycomb structure is joined to the assembly by brazing either during an engine overhaul or in the original manufacturing process. This allows ease of replacement during the overhaul. This allows the removal and replacement of first honeycomb layer 40 (or 140) if desired without replacing the entire stator seal portion 33.

As depicted, a CAD model file is received by a print controller at step 400. The parts, for example, 50, 60 and 70, or 150, 160, 170 are printed as a single structure at step 402. Next a honeycomb layer 40, 60 is obtained at step 404 and brazed to the printed structure at step 406. In a subsequent step, 408, a determination is made if perforations 52, 71 are required and if so, they are formed in a machining process at step 410. If no perforations 52, 71 are required, the braze is inspected at step 412. A final inspection may be performed and/or the part released at step 414.

The foregoing description of structures and methods has been presented for purposes of illustration. It is not intended to be exhaustive or to limit the structures and methods to the precise forms and/or steps disclosed, and obviously many modifications and variations are possible in light of the above teaching. Features described herein may be combined in any combination. Steps of a method described herein may be performed in any sequence that is physically possible. It is understood that while certain forms of composite structures have been illustrated and described, it is not limited thereto and instead will only be limited by the claims, appended hereto.

While multiple inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize, or be able to ascertain using no more than routine experimentation, many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

Examples are used to disclose the embodiments, including the best mode, and also to enable any person skilled in the art to practice the apparatus and/or method, including making and using any devices or systems and performing any incorporated methods. These examples are not intended to be exhaustive or to limit the disclosure to the precise steps and/or forms disclosed, and many modifications and variations are possible in light of the above teaching. Features described herein may be combined in any combination. Steps of a method described herein may be performed in any sequence that is physically possible.

All definitions, as defined and used herein, should be understood to control over dictionary definitions, definitions in documents incorporated by reference, and/or ordinary meanings of the defined terms. The indefinite articles “a” and “an,” as used herein in the specification and in the claims, unless clearly indicated to the contrary, should be understood to mean “at least one.” The phrase “and/or,” as used herein in the specification and in the claims, should be understood to mean “either or both” of the elements so conjoined, i.e., elements that are conjunctively present in some cases and disjunctively present in other cases.

It should also be understood that, unless clearly indicated to the contrary, in any methods claimed herein that include more than one step or act, the order of the steps or acts of the method is not necessarily limited to the order in which the steps or acts of the method are recited.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

What is claimed is:

1. A laminate seal assembly disposed on a stator seal portion and opposite a rotor seal portion of a gas turbine engine, comprising:
a first honeycomb layer having a first edge which engages said rotor seal portion and a second edge distal from said rotor seal portion, a plurality of cells extending between said first edge and said second edge;
an intermediate seal plate having a first material surface and a second material surface, said first material surface disposed against said second edge of said first honeycomb layer;
a low conductivity structure disposed on said second material surface; and,
a backing plate disposed against said low conductivity structure;
wherein said stator portion may be tuned for thermal growth to match the thermal growth of said rotor portion.

2. The laminate seal assembly of claim 1 wherein at least one of said intermediate seal plate and said backing plate includes a plurality of transient match tuning perforations.

3. The laminate seal assembly of claim 2 wherein said transient match tuning perforations being one of same size or differing size.

4. The laminate seal assembly of claim 3 wherein said transient match tuning perforations being at least one of randomly placed or placed in a pattern.

5. The laminate seal assembly of claim 1 wherein said intermediate seal plate is a metallic sheet.

6. The laminate seal assembly of claim 1 wherein said low conductivity structure is a ceramic matrix composite.

7. The laminate seal assembly of claim 1 wherein said low conductivity structure is a second honeycomb layer.

8. The laminate seal assembly of claim 1 further comprising perforations in said intermediate seal plate for air communication between said first honeycomb layer and said low conductivity structure.

9. The laminate seal assembly of claim 8 wherein said perforations in said intermediate seal plate are of consistent size.

10. The laminate seal assembly of claim 9 wherein said perforations in said intermediate seal plate are at least two differing sizes.

11. The laminate seal assembly of claim 1 wherein said cells each being a geometric shape.

12. The laminate seal assembly of claim 11 wherein said cells being of consistent size.

13. The laminate seal assembly of claim 11, said cells being of varying size.

14. The laminate seal assembly of claim 11, said cells being of varying height.

15. A method of forming a laminate seal assembly comprising:
receiving one of a model or CAD file at a processor;
printing a 3-dimensional part from said model or CAD file, said part being all or a portion of a stator seal portion;
brazing at least one honeycomb layer to said stator seal portion and decreasing inspections of said laminate seal beyond one.
